(19) United States
(12) Patent Application Publication
(10) Pub. No.: US 2008/0317184 A1
(43) Pub. Date: Dec. 25, 2008

(54) METHOD FOR TRANSMITTING SYNCHRONIZATION SIGNAL IN MOBILE MULTIMEDIA SYSTEM

(76) Inventors: Hui ZHANG, Beijing (CN); Junyun Yang, Beijing (CN); Fei Meng, Beijing (CN); Yu Xu, Beijing (CN); Jiongliang Li, Beijing (CN)

Correspondence Address: Pearl Cohen Zedek Latzer, LLP, 1500 Broadway, 12th Floor, New York, NY, 10036, US

(21) Appl. No.: 12/145,746

(22) Filed: Jun. 25, 2008

(30) Foreign Application Priority Data
Jun. 25, 2007 (CN) 200710117836.X

(51) Int. Cl. H04L 7/00

(52) U.S. Cl. 375/367; 375/365

(57) ABSTRACT

The present invention discloses a method for transmitting a synchronization signal in a mobile multimedia system. In the method, a transmitter of the system transmits a synchronization signal sequence at a regular interval. The methods includes: generating a first synchronization signal sequence; generating a second synchronization signal sequence by performing a reversible transform for the first synchronization signal sequence; and transmitting the first and the second synchronization signal sequences in cascade. By the method provided by the present invention for transmitting a synchronization signal in a mobile multimedia system, a channel with wider delay spread can be handled, more precise and stabler synchronization performance can be achieved and the channel estimation module can be helped to get more accurate channel frequency domain response.

### CROSS REFERENCE TO RELATED APPLICATIONS

This application claims the benefit of Chinese Patent Application No. 200710117836.X, filed on Jun. 25, 2007, which is incorporated in its entirety herein by reference.

### FIELD OF THE INVENTION

The present invention relates to the mobile multimedia broadcast technology, and particularly to a method for transmitting a synchronization signal in a mobile multimedia system.

### BACKGROUND OF THE INVENTION

Synchronization module for synchronizing signals of a receiver is one of key modules in all kinds of systems, especially in a wireless communication system. The receiver may adopt varieties of technical schemes, including a blind synchronization scheme and a non-blind synchronization scheme, to implement signal synchronization. In the blind synchronization scheme, a transmitter need not transmit any special signal and the receiver synchronizes signals according to the inherent pattern of transmitted signals, wherein the special signal is a signal known to the receiver. In the non-blind synchronization scheme, the transmitter transmits a special signal and the receiver searches for the special signal and synchronizes signals according to the special signal. Most of existing systems, including the system based on IEEE 802.16, based on IEEE 802.11a or based on China Mobile Multimedia Broadcasting (CMMB) standard GY/T 220.1-2006, adopt the non-blind synchronization scheme, i.e., the transmitter transmits the special signal.

### SUMMARY OF THE INVENTION

The objective of the present invention is to provide a method for transmitting a synchronization signal in a mobile multimedia system to improve the accuracy of the estimation of the time-domain impulse response on a channel with delay spread and further to obtain better channel estimation.

To attain the above objective, the present invention provides a method for transmitting a synchronization signal in a mobile multimedia broadcast system. In the method, a transmitter of the mobile multimedia broadcast system transmits a synchronization signal sequence at a regular interval, and the method includes:

generating a first synchronization signal sequence;

generating a second synchronization signal sequence by performing a reversible transform for the first synchronization signal sequence; and

transmitting the first and the second synchronization signal sequences in cascade.

The present invention also provides a method for transmitting a synchronization signal in a mobile multimedia broadcast system. In the method, a transmitter of the mobile multimedia broadcast system transmits a synchronization signal sequence at a regular interval, and the method includes:

generating a first synchronization signal sequence, wherein the length of the first synchronization signal sequence is 409.6 μs;

generating a second synchronization signal sequence according to the first synchronization signal sequence, wherein the length of the second synchronization signal sequence is 409.6 μs and there is a corresponding relation between the first synchronization signal sequence and the second synchronization signal sequence;

transmitting the first and the second synchronization signal sequences in cascade.

Another objective of the present invention is to provide a method for generating a synchronization signal sequence in a mobile multimedia broadcast system. After the synchronization signal sequence generated by the method is transmitted, the accuracy of estimation of time-domain impulse response on a channel with delay spread may be improved and the better channel estimation may be achieved.

To attain the above objective, the present invention provides a method for generating a synchronization signal sequence in a mobile multimedia broadcast system, including:

generating a binary pseudo-random noise (PN) sequence and converting the binary PN sequence into a time-domain band-limited signal by Inverse Fourier Transform (IFT), wherein the PN sequence is generated by shift registers according to a polynomial x¹²+x⁶+x⁴+x¹+1 and an initial value of the shift registers is 101110101101.

By the method provided by the present invention for generating and transmitting a synchronization signal in a mobile multimedia system, the channel with wide delay spread can be handled, more precise and stabler synchronization performance can be achieved and the channel estimation module can be helped to get more accurate channel frequency domain response.

### BRIEF DESCRIPTION OF THE DRAWINGS

FIG. 1 is a schematic diagram illustrating a synchronization signal provided by the GY/T 220.1-2006 standard.

FIG. 2 is a schematic diagram illustrating linear feedback shift registers adopting the GY/T220.1-2006 standard.

FIG. 3 is a flowchart illustrating a method for transmitting a synchronization signal according to an embodiment of the present invention.

FIG. 4 is a schematic diagram illustrating liner feedback shift registers according to an embodiment of the present invention.

FIG. 5 is a schematic diagram illustrating a synchronization signal according to another embodiment of the present invention.

FIG. 6 is a flowchart illustrating a method for transmitting a synchronization signal according to another embodiment of the present invention.

### DETAILED DESCRIPTION OF THE INVENTION

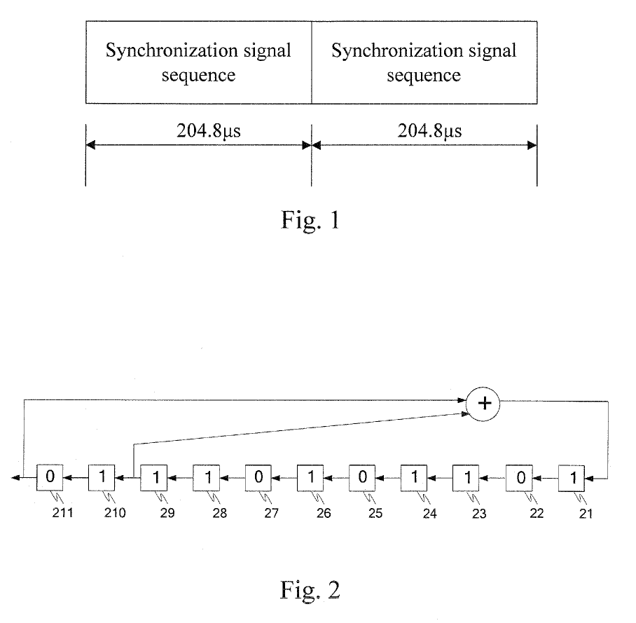

FIG. 1 shows a schematic diagram illustrating a synchronization signal provided by the GY/T 220.1-2006 standard.

The CMMB standard GY/T 220.1-2006 adopts a technical scheme in which two identical synchronization signal sequences are cascaded. Each synchronization signal sequence is a pseudo-random signal with a limited frequency band, and the length of each synchronization signal sequence is 204.8 μs. For a bandwidth of 8 MHz, the number of base band sampling points of a synchronization signal is 2048; and for a bandwidth of 2 MHz, the number of base band sampling points of a synchronization signal is 512. The generation process of a synchronization signal sequence includes generating a binary pseudo-random sequence by shift registers and converting the binary pseudo-random sequence into a time domain band-limited signal through Inverse Fourier Transform (IFT).

On the receiving end, the synchronization process includes: locating the starting point of a valid signal, estimating fractional frequency offset, estimating integer frequency offset and estimating channel time-domain impulse response, etc. By searching out a maximum autocorrelation value in the autocorrelation of two synchronization signals, the starting point of a valid signal is located and the fractional frequency offset is estimated; and through the cross-correlation of a local synchronization signal and a received synchronization signal, the integer frequency offset and the channel time-domain impulse response are estimated.

However, a longer synchronization signal is needed if a channel time-domain impulse response with wide delay spread is desired. In addition, the longer synchronization signal may increases the accuracy and stability of the synchronization module.

GY/T 220.1-2006 adopts Orthogonal Frequency Division Multiplexing (OFDM) as a channel modulation scheme and scattered pilot is embedded at the transmitting end to implement the channel estimation at the receiving end. In the existing channel estimation technique, information including delay spread is needed to search out a proper channel estimation coefficient group, hence the accuracy of the channel time-domain impulse response estimation directly affect the accuracy of the channel estimation.

The GY/T 220.1-2006 standard provides a generation process of a synchronization signal sequence as follows.

The synchronization signal S_{b}(t) is a pseudo-random signal with a limited frequency band, the length of the synchronization signal is T_{b} and the value of the synchronization signal is 204.8 μs. The synchronization signal is expressed by the following equation:

$${S}_{b} ( t ) = \frac{1}{{N}_{b}} {\sum }_{i = 0}^{{N}_{b} - 1} {X}_{b} ( i ) {e}^{j2π {i ( Δ f )}_{b} t} , 0 \leq t \leq {T}_{b}$$

In the equation,

N_{b} expresses the number of sub-carriers of the synchronization signal;

X_{b}(i) expresses a Binary Phase Shift Keying (BPSK) modulation signal that carries the binary pseudo-random sequence PN_{b}(k); and

(Δf)_{b} expresses the interval between the sub-carriers of the synchronization signal, and the value of the interval is 4.8828125 Khz.

The number of the sub-carriers of the synchronization signal N_{b} is expressed according to the physical layer bandwidth (B_{f}) as follows:

$${N}_{b} = \{ \begin{matrix}2048 , & {B}_{f} = 8 Mhz \\ 512 , & {B}_{f} = 2 Mhz\end{matrix}$$

The BPSK modulation signal X_{b}(i) that carries the binary pseudo-random noise sequence PN_{b}(k) is generated by mapping PN_{b}(k), and the mapping process is shown as follows:

$${B}_{f} = 8 Mhz \text{:} {X}_{b} ( i ) = \{ \begin{matrix}1 - 2 \times {PN}_{b} ( i - 1 ) , 1 \leq i \leq 768 \\ 0 , i = 0 »ò769 \leq i \leq 1279 \\ 1 - 2 \times {PN}_{b} ( i - 512 ) , 1280 \leq i \leq 2047\end{matrix} \\ {B}_{f} = 2 Mhz \text{:} {X}_{b} ( i ) = \{ \begin{matrix}1 - 2 \times {PN}_{b} ( i - 1 ) , 1 \leq i \leq 157 \\ 0 , i = 0 , 158 \leq i \leq 354 \\ 1 - 2 \times {PN}_{b} ( i - 198 ) , 355 \leq i \leq 511\end{matrix}$$

FIG. 2 shows a schematic diagram illustrating linear feedback shift registers adopting the GY/T220.1-2006 standard The binary pseudo-random sequence is generated by the linear feedback shift registers in FIG. 2, and the generation process is expressed by a polynomial x¹¹+x⁹+1; the initial values of the shift registers are 01110101101 and always remain the same for every synchronization signal.

The eleven shift registers in FIG. 2 are marked respectively from right to left as Register 21, Register 22 . . . Register 211. The data to the right of a register are input data of the register and the data to the left of the register are output data of the register, i.e., the output data is the value of the register. The output data of Register 211 is the output data of the whole register group. The values of the registers are set as the given initial values in turn. After the setting of the initial values, modulo 2 sum of the output value of Register 211 and the output value of Register 29 is performed to obtain a result; then at every clock cycle, the value of Register 210 is assigned to Register 211, the value of Register 29 is assigned to Register 210, . . . , the value of Register 21 is assigned to Register 22, and the result of the modulo 2 sum is assigned to Register 21; after that the modulo 2 sum is performed again to obtain a new result. Meanwhile, the output sequence of Register 211 is the binary pseudo-random sequence.

It can be concluded that the present generation process of a synchronization signal sequence includes: generating the binary PN sequence and converting the binary PN sequence into a time-domain band-limited signal by IFT. The PN sequence is generated by shift registers according to the polynomial x¹¹+x⁹ +1 and the initial values of the shift registers is 01110101101.

In a system adopting GY/T 220.1-2006 standard, the transmitting end transmits a synchronization signal at a regular interval and the transmission process includes: generating a synchronization signal sequence of 204.8 μs, generating another synchronization signal sequence of 204.8 μs and transmitting the two synchronization signal sequences in cascade.

The synchronization signal sequence generation method and the synchronization signal transmission method provided by the GY/T 220.1-2006 standard make it disadvantageous to estimate the time-domain impulse response on a channel with wide delay spread and further to make the channel estimation through the scattered pilot; in addition, the length of the synchronization signal provided by the GY/T 220.1-2006 standard is too short.

In the present invention, a corresponding relation between two synchronization signal sequences is determined, and then the two synchronization signal sequences are generated and transmitted in cascade. In this way, the present invention may improve the accuracy of the estimation of time-domain impulse response on a channel with delay spread and provide channel estimation better than the existing synchronization signal transmission method does.

The present invention further provides a longer synchronization signal sequence.

In addition, the present invention also provides a method for generating a synchronization signal sequence.

A detailed description of embodiments of the present invention is provided hereinafter with reference to the attached drawings.

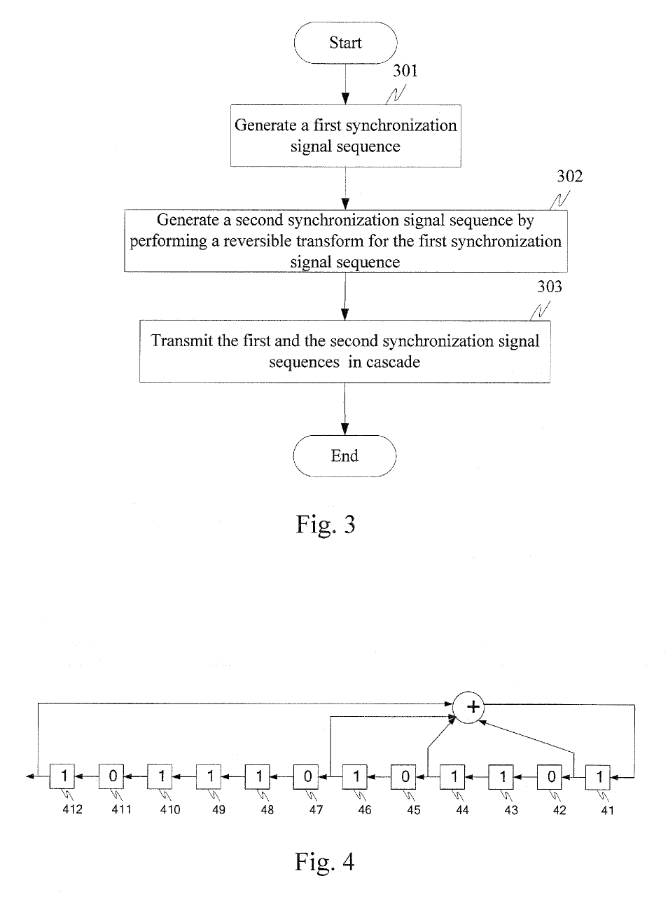

FIG. 3 is a flowchart illustrating a method for transmitting a synchronization signal according to an embodiment of the present invention. The method includes the following processes.

Block 301: A first synchronization signal sequence is generated.

The generation process of the first synchronization signal sequence includes: generating a binary PN sequence and converting the binary PN sequence into a time-domain band-limited signal by IFT. The PN sequence is generated by shift registers according to a polynomial x¹²+x⁶+x⁴+x¹+1 and the initial values of the shift registers is 101110101101.

Block 302: A second synchronization signal sequence is generated by performing a reversible transform for the first synchronization signal sequence.

The length of the first synchronization signal sequence and the length of the second synchronization signal sequence are all 409.6 μs.

The reversible transform may include a conjugate operation and a transposed operation to determine a specific corresponding relation between the first synchronization signal sequence and the second synchronization signal sequence. The transposed operation means the reverse of a sequence, including: making the last sample of an original sequence as the first sample of a new sequence, making the second last sample of the original sequence as the second sample of the new sequence, . . . , making the first sample of the original sequence as the last sample of the new sequence.

Block 303: The first and the second synchronization signal sequences are transmitted in cascade.

The generation of the synchronization signal sequence is described hereinafter:

The synchronization signal S_{b}(t) is a pseudo-random signal with a limited frequency band, the length of the synchronization signal is T_{b} and the value of the synchronization signal is 409.6.8 μs. The synchronization signal is expressed by the following equation:

$${S}_{b} ( t ) = \frac{1}{{N}_{b}} {\sum }_{i = 0}^{{N}_{b} - 1} {X}_{b} ( i ) {e}^{j2π {i ( Δ f )}_{b} t} , 0 \leq t \leq {T}_{b}$$

In the equation,

N_{b} expresses the number of sub-carriers of the synchronization signal;

X_{b}(i) expresses a BPSK modulation signal that carries the binary pseudo-random sequence PN_{b}(k); and

(Δf)_{b} expresses the interval between the sub-carriers of the synchronization signal, the value of the interval is 2.44140625 Khz.

The number of the sub-carriers of the synchronization signal N_{b} is expressed according to the physical layer bandwidth (B_{f}) as follows:

$${N}_{b} = \{ \begin{matrix}4096 , & {B}_{f} = 8 Mhz \\ 1024 , & {B}_{f} = 2 Mhz\end{matrix}$$

The BPSK modulation signal X_{b}(i) that carries the binary pseudo-random noise sequence PN_{b}(k) is generated by mapping PN_{b}(k), and the mapping process is shown as follows:

$${B}_{f} = 8 Mhz \text{:} {X}_{b} ( i ) = \{ \begin{matrix}1 - 2 \times {PN}_{b} ( i - 1 ) , 1 \leq i \leq 1538 \\ 0 , i = 0 , 1539 \leq i \leq 2557 \\ 1 - 2 \times {PN}_{b} ( i - 1020 ) , 2558 \leq i \leq 4095\end{matrix} \\ {B}_{f} = 2 Mhz \text{:} {X}_{ID} ( i ) = \{ \begin{matrix}1 - 2 \times {PN}_{b} ( i - 1 ) , 1 \leq i \leq 314 \\ 0 , i = 0 , 315 \leq i \leq 709 \\ 1 - 2 \times {PN}_{b} ( i - 396 ) , 710 \leq i \leq 1023\end{matrix}$$

FIG. 4 is a schematic diagram illustrating liner feedback shift registers according to an embodiment of the present invention. The binary pseudo-random sequence PN_{b}(k) is generated by the linear feedback shift registers shown in FIG. 4, and the generation process is expressed by a polynomial x¹²+x⁶+x⁴+x¹+1. The initial values of the shift registers are 101110101101 and always remain the same for every synchronization signal.

The twelve shift registers in FIG. 4 are marked respectively from right to left as Register 41, Register 42 . . . Register 411 and Register 412. The data to the right of a register are input data of the register and the data to the left of the register are output data of the register, i.e., the output data is the value of the register. The output data of Register 412 is the output data of the whole register group. The values of the registers are set as the given initial values in turn. After the setting of the initial values, modulo 2 sum of the output values of Registers 412, 46, 44 and 41 is performed to obtain a result; then at every clock cycle, the value of Register 411 is assigned to Register 412, the value of Register 410 is assigned to Register 411, . . . , the value of Register 41 is assigned to Register 42, and the result of the modulo 2 sum is assigned to Register 41; after that the modulo 2 sum is performed again to obtain a new result. Meanwhile, the output sequence of Register 412 is the binary pseudo-random sequence.

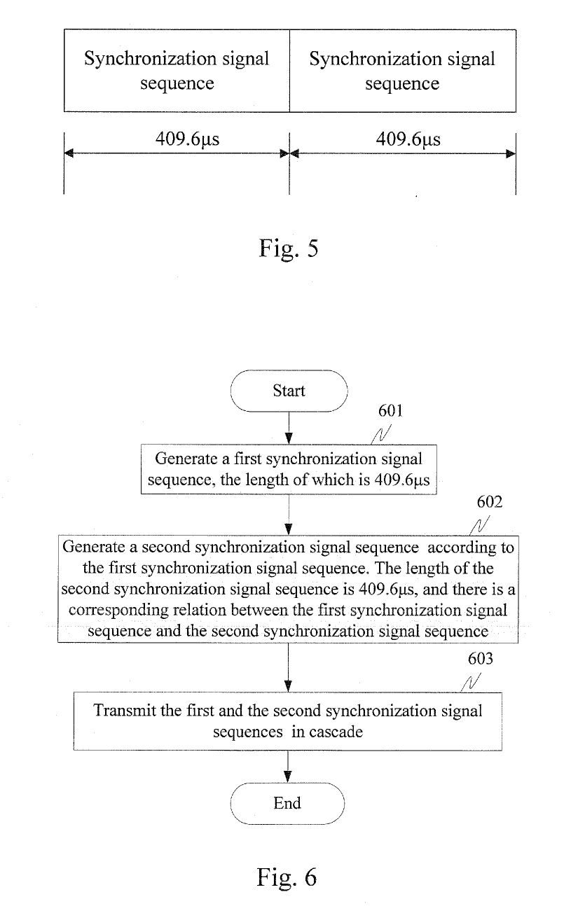

FIG. 5 is a schematic diagram illustrating a synchronization signal according to another embodiment of the present invention. The synchronization signal includes two cascaded synchronization signal sequences: the first synchronization signal sequence and the second synchronization signal sequence. The second synchronization signal sequence is generated by performing a reversible transform for the first synchronization signal sequence. The length of the first synchronization signal sequence and the length of the second synchronization signal sequence are all 409.6 μs.

FIG. 6 is a flowchart illustrating a method for transmitting a synchronization signal according to another embodiment of the present invention. The method includes the following processes.

Block 601: A first synchronization signal sequence is generated, the length of which is 409.6 μs.

The generation process of the first synchronization signal sequence includes: generating a binary PN sequence and converting the binary PN sequence into a time-domain band-limited signal by IFT. The PN sequence is generated by shift registers according to a polynomial x¹²+x⁶+x⁴+x¹+1 and the initial value of the shift registers is 101110101101.

Block 602: A second synchronization signal sequence is generated according to the first synchronization signal sequence. The length of the second synchronization signal sequence is 409.6 μs, and there is a specific corresponding relation between the first synchronization signal sequence and the second synchronization signal sequence.

The corresponding relation may include that the second synchronization signal sequence is identical to the first synchronization signal sequence.

Or, the corresponding relation may include that the second synchronization signal sequence is generated by performing a reversible transform for the first synchronization signal sequence. The reversible transform may include a conjugate operation and a transposed operation. Just as in the above embodiment, the transposed operation includes: making the last sample of an original sequence as the first sample of a new sequence, making the second last sample of the original sequence as the second sample of the new sequence, . . . , making the first sample of the original sequence as the last sample of the new sequence.

Block 603: The first and the second synchronization signal sequences are transmitted in cascade.

The generation process of the synchronization signal sequences is identical to the generation process in the above embodiment.

After synchronization signal sequences are generated according to the synchronization signal sequence method, the synchronization signal sequences are transmitted according to the synchronization signal transmission method provided by the present invention, which help to handle multi-path channel with wide delay spread in the mobile multimedia broadcast system; in addition, the length of the synchronization signal sequence generated according to the present invention is longer, which can guarantee more precise and stabler synchronization performance and helps channel estimation scheme based on the scattered pilot to achieve better performance.

Obviously the embodiments provided herein are not for use in limiting the present invention; any equivalent alteration and modification made by those skilled in the field to the technical features of the present invention should be included in the protection scope of the present invention.

What is claimed is:

1. A method for transmitting a synchronization signal in a mobile multimedia broadcast system, wherein a transmitter of the mobile multimedia broadcast system transmits a synchronization signal sequence at a regular interval, the method comprising:
generating a first synchronization signal sequence;
generating a second synchronization signal sequence by performing a reversible transform for the first synchronization signal sequence; and
transmitting the first and the second synchronization signal sequences in cascade.

2. The method of claim 1, wherein the reversible transform comprises a conjugate operation.

3. The method of claim 1, wherein the reversible transform comprises a transposed operation.

4. The method of claim 1, wherein the length of the first synchronization signal sequence and the length of the second synchronization signal sequence are 409.6 μs.

5. The method of claim 1, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴+x¹+1 and an initial value of the shift registers is 101110101101.

6. The method of claim 4, wherein the generating the first synchronization signal sequence comprises:
generating a binary PN sequence and converting the binary PN sequence into a time-domain band-limited signals by Inverse Fourier Transform (IFT), wherein the binary PN sequence is generated by shift registers according to a polynomial x¹²+x⁶+x⁴+x¹+1 and an initial value of the shift registers is 101110101101.

7. The method of claim 2, wherein the length of the first synchronization signal sequence and the length of the second synchronization signal sequence are 409.6 μs.

8. The method of claim 7, wherein the generating the first synchronization signal sequence comprises:
generating a binary PN sequence and converting the binary PN sequence into a time-domain band-limited signals by Inverse Fourier Transform (IFT), wherein the binary PN sequence is generated by shift registers according to a polynomial x¹²+x⁶+x⁴+x¹+1 and an initial value of the shift registers is 101110101101.

9. The method of claim 2, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴x¹+1 and an initial value of the shift registers is 101110101101.

10. A method for transmitting a synchronization signal in a mobile multimedia broadcast system, wherein a transmitter of the mobile multimedia broadcast system transmits a synchronization signal sequence at a regular interval, the method comprising:
generating a first synchronization signal sequence, wherein the length of the first synchronization signal sequence is 409.6 μs;
generating a second synchronization signal sequence according to the first synchronization signal sequence, wherein the length of the second synchronization signal sequence is 409.6 μs and there is a corresponding relation between the first synchronization signal sequence and the second synchronization signal sequence; and
transmitting the first and the second synchronization signal sequences in cascade.

11. The method of claim 10, wherein the corresponding relation comprises that the second synchronization signal sequence is identical to the first synchronization signal sequence.

12. The method of claim 11, wherein the corresponding relation comprises that the second synchronization signal sequence is generated by performing a reversible transform for the first synchronization signal sequence.

13. The method of claim 12, wherein the reversible transform includes a conjugation operation.

14. The method of claim 12, wherein the reversible transform comprises a transposition operation.

15. The method of claim 10, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴+x¹+1 and an initial value of the shift registers is 101110101101.

16. The method of claim 11, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴+x¹+1 and an initial value of the shift registers is 101110101101.

17. The method of claim 12, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴+x¹+1 and an initial value of the shift registers is 101110101101.

18. The method of claim 13, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴+x¹+1 and an initial value of the shift registers is 101110101101.

19. The method of claim 14, wherein the generating the first synchronization signal sequence comprises:
generating a binary pseudo-random noise (PN) sequence and converting the binary PN sequence into a time-domain band-limited signal by Inverse Fourier Transform (IFT), wherein the binary PN sequence is generated by shift registers according to a polynomial x¹²+x⁶+x⁴+x¹+1 and an initial value of the shift registers is 101110101101.

20. A method for generating a synchronization signal sequence in a mobile multimedia broadcast system, comprising:
generating a binary pseudo-random noise (PN) sequence and converting the binary PN sequence into a time-domain band-limited signal by Inverse Fourier Transform (IFT), wherein the PN sequence is generated by shift registers according to a polynomial x¹²+x⁶+x⁴+x¹+1 and an initial value of the shift registers is 101110101101.
